(19) United States
(12) Patent Application Publication
(10) Pub. No.: US 2015/0352810 A1
(43) Pub. Date: Dec. 10, 2015

(54) GRAFFITI COVERING SKIN

(71) Applicants: Jeffrey GREEN, Anaheim, CA (US); Michael SCHUCH, Anaheim, CA (US)

(72) Inventors: Jeffrey GREEN, Anaheim, CA (US); Michael SCHUCH, Anaheim, CA (US)

(21) Appl. No.: 14/831,655

(22) Filed: Aug. 20, 2015

Related U.S. Application Data
(63) Continuation-in-part of application No. 14/195,347, filed on Mar. 3, 2014.
(60) Provisional application No. 61/890,484, filed on Oct. 14, 2013.

(51) Int. Cl. B32B 7/06; B44F 9/04; B44F 9/02; B44C 1/10; B32B 27/32; B32B 27/36; B32B 27/08; B32B 7/12; B44F 9/10

(52) U.S. Cl. CPC B32B 7/06; B32B 7/12; B44F 9/04; B44F 9/02; B44F 9/10; B32B 27/32; B32B 27/36; B32B 27/08; B44C 1/10; B32B 2307/412; B32B 2307/414; B32B 2307/42; B32B 2250/05; B32B 2419/00; B32B 2451/00

(57) ABSTRACT

Improvements in a graffiti covering skin are disclosed the covering skin is formed from multiple layers of different materials. Each layer of the skin provides different functions to provide a material that covers existing graffiti and creates a new surface that reduces or repels future graffiti from being placed on the original host surface. One of the layers is thin visual pattern layer that provides the desired appearance of a hard surface of stainless steel, wood, color, marble, granite or light filtering. This layer provides a structural rigidity that maintains dimensional stability. The thickness of the skin is sufficient to cover imperfections, scratches or gouges in the surface being covered. The skin is backed with a removable adhesive that is removed from a host surface without leaving a residue. Each skin is measured and cut to the desired size before placement on the host surface.

### CROSS REFERENCE TO RELATED APPLICATIONS

This application claims priority to application Ser. No. 14/195,347 filed on Mar. 3, 2014 which claims the benefit of Provisional Application Ser. No. 61/772,674 filed Mar. 5, 2013 and Provisional Application Ser. No. 61/890,484 filed Oct. 14, 2013 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

This invention relates to improvements in a film covering to cover graffiti, damage, scratches, wear and tear on a host surface, to reduce future vandalism and simulates, improves or modifies the surface it covers. More particularly, the present covering skin provides a multi-layered skin that is thick enough to cover surface scratches. The skin can be removed and replaced periodically or when extensively damaged by vandals on surfaces such as but not limited to escalator sides, elevators, doors, windows, walls, counters and restroom partitions.

Description of Related Art including information disclosed under 37 CFR 1.97 and 1.98.

Most public places are susceptible to damage by vandals. Vandalism can take many forms including but not limited to tagging by paint, markers and scraping. For all of these forms of vandalism the outer surface becomes cosmetically altered. When the damage is from painting or markers the surface can be chemically cleaned. Often the cleaning process creates further damage to the surface. For damage caused by scraping or scratching the surface, cleaning is not effective, and sanding the surface may remove legibility of the markings, the surface will still be cosmetically unpleasing. The vandalism can be scratches to counters, elevators, walls, wood, metal and glass surfaces.

Proactive efforts to cover a transparent glass surface, such as a window or mirror, require covering one or both sides of the glass surface with a covering or skin that is easily removable and replaceable without significantly altering the opacity of the glass or window. Some prior art discloses a window treatment that provides filtering of the light through a window. These filter skins are placed on the inside of the window and are destroyed when removed and can't be reused. These filtering films further are fragile and can be easily damaged by vandals thereby making them ineffective against vandalism because they are more easily damaged.

A number of patents and or publications have been made to address these issues. Exemplary examples of patents and or publication that try to address this/these problem(s) are identified and discussed below.

U.S. Pat. No. 5,019,442 issued on May 29, 1991 to Tadatoshi Ogawa et al., disclose an Overlay films. The overlay film of the invention is obtained by on at least one side of the base layer composed of a crystalline polyolefin forming a substrate layer composed of a resin composition comprising an ethylene copolymer such as ethylene-methacrylic acid ester copolymer and the like and a crystalline polyolefin. This film only provides protection to a base layer before the base layer is damaged, it does not provide a thick covering that covers surface damage and provides a similar cosmetic appearance.

U.S. Pat. No. 6,835,269 issued on Dec. 28, 2004 to Kenji Miharu et al., discloses a laminated film and method of producing the same. Discloses a laminated film exhibiting excellent interlayer adhesiveness obtained by extrusion-laminating a resin directly on a polyester film without effecting anchor-coating or without treating the molten film of the extrusion-laminated resin with ozone. The film provides a label where the layers remain bonded, but does not include a stainless steel layer for structural strength and dimensional stability nor is the laminate thick enough to cover surface damage.

U.S. Pat. No. 5,242,751 issued on Sep. 9, 1993 to Marvis E. Hartman discloses Paint Composites. The paint composite article has a thermally deformable carrier film having an adhesive layer on one surface and a paint layer on its other surface. While the disclosure in this patent can be used to cover a wall surface it is covered with paint and the paint is not stiff enough to cover gouges damage to the prior surface.

U.S. Pat. No. 7,727,607 issued on Jun. 1, 2010 to Frank Yen-Jer Shih et al., discloses a Multi-layer dry paint decorative laminate having discoloration prevention barrier. The laminate uses a decorative dry paint wall film includes a layer of dry paint, a pressure-sensitive adhesive layer on one side of the dry paint layer. The paint layer does not provide a rigid surface to cover surface imperfections and is further not hard enough to prevent gouging from vandals.

U.S. Patent Publication Number 2008/0233365 that issued on Sep. 25, 2008 to Robert G. Pierson; discloses a Decorative Laminate With Graffiti Resistance and Improved Combustion Reaction Properties. The decorative laminate includes a polymer or engineered film with fluorine, a decorative pattern visible through the polymer film, and a substrate supporting the polymer film and decorative pattern. An embossing layer may be included between the polymer film and substrate. The film provides a decorative layer, but does not include a stainless steel layer for structural strength and dimensional stability nor is the laminate thick enough to cover surface damage.

What is needed is a covering that simulates the appearance of the surface they cover and covers surface damage such as, but not limited to cover graffiti, damage, scratches, wear and tear on a host surface such as but not limited to escalator sides, elevators, doors, windows, walls, counters and restroom partitions. The proposed Graffiti covering skin provides the solution with a removable skin that simulates or covers the original surface and covers any existing graffiti and surface damage.

### BRIEF SUMMARY OF THE INVENTION

It is an object of the graffiti covering skin to be formed from multiple layers of different materials. Each layer of the graffiti covering skin provides different functions to provide a material that both covers existing graffiti, damage, scratches, wear and tear on a host surface and creates a new surface that reduces or repels future graffiti from being placed on the original host surface.

It is an object of the graffiti covering skin to provide a cosmetic appearance of smooth, mirror, textures, wood grain, marble, and granite, color, filtering, brushed or textured surface. At least one of the layers is a thin layer of cosmetic material or a layer that provides the appearance of a stainless steel, wood grain, marble, granite, color, or transparent surface. The cosmetic appearance can be from printing, painting, screening, brushing, or other processes. This layer provides a structural rigidity that maintains dimensional stability. It reacts like a sheet of material that is much thicker than the individual layer of material that is being used. The thickness of the graffiti covering skin is sufficient to cover imperfections, scratches or gouges in the surface that is being covered.

It is another object of the graffiti covering skin to be removable without leaving a residue on the host surface. The base surface of the graffiti covering skin is an adhesive that is retained on the graffiti covering skin to a higher degree than the adhesive sticks on the host surface. In fabrication, a release liner is used to prevent contamination of the adhesive layer before the adhesive layer is bonded to the host surface. This adhesive layer is low tack adhesive that when the graffiti covering skin is peeled away from the host surface the adhesive remains on the graffiti covering skin. This eliminates any residue from remaining on the host surface and allows for placement or replacement of the graffiti covering skin.

It is still another object of the graffiti covering skin for each skin to be measured and cut to the desired size before placement on the host surface. Each host surface is pre-measured to determine the optimal size and shape of the graffiti covering skin. The skin or skins can be cut and fabricated at a factory that is located away from the site of installation, or can be fabricated, modified or trimmed at the place of installation. The skin or skins can then be transported or moved to the host surface for installation where the backing skin is removed and placed onto the host surface.

It is still another object of the graffiti covering skin for each skin to provide light filtering. The light filtering reduces utility costs and damage caused by harmful sunlight rays that enter an unprotected window. The skin can be placed on one or both sides of a storefront window, or transportation vehicle window such as a train or bus to provide damage protection from vandals that may attack the outside of the business as well as provide protection on the inside of the business window. Because the skin can be easily removed and replaced it is contemplated that the amount of window filtering can be altered at different times of the year to provide high levels of sun filtering in summer months and low levels of filtering in winter months when outside sunlight is less.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows the layers of the laminate.

FIG. 2 shows a wall that has been damaged by graffiti.

FIG. 3 shows the base surface from FIG. 2 that has been partially covered with the graffiti skin.

FIG. 4 shown the steps used to cover an existing base wall or surface.

### DETAILED DESCRIPTION OF THE INVENTION

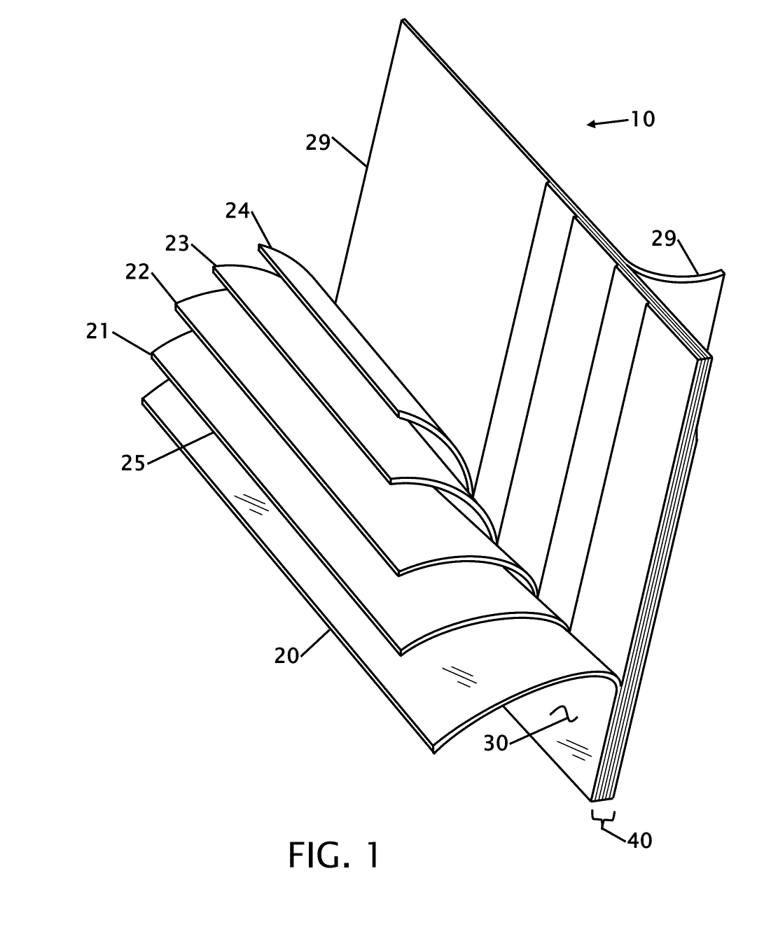

FIG. 1 shows the construction layers of the graffiti covering skin 10. In this preferred embodiment the graffiti covering skin 10 has an outer layer comprising a satin finish protective coat 20 has an outer layer 30 that can also be satin, flat, high gloss or other desired finish. The protective surface is transparent or translucent and may be colored to provide a tint to any underlying layers. This outer surface 20 repels some damage from vandalism and is provides a smooth cosmetic surface for protection of the next layer. The outer surface is also acid resistant.

The next layer is a visual pattern or filtering overlay 21. In one preferred embodiment this layer is a stainless steel overlay 21 has an outer cosmetic surface 25 that has the desired appearance and texture. In some embodiments this can be a brushed finish, a satin finish, a mirror, a reflective or other finish as desired or specified by the customer. In the preferred embodiment the stainless steel overlay 21 is 0.0005″ to 0.0250″ thick. It is also contemplated that this surface can be a screened, printed or painted surface of material that simulates the desired stainless steel, copper, brass, wallpaper or other desired surface to match an existing substrate. The appearance of covered surface can be changed, as an example of an elevator being changed from bronze to stainless steel to provide an updated appearance. The exterior surface is not applied in a thermal vacuum formed process. While painting is disclosed as a possible surface coating on the outer surface of the overlay, the overlay is not paint that is applied directly to a surface. The overlay is also not intended for use on painted walls or surfaces. The overlay is further not intended to be a discoloration barrier.

In another preferred embodiment the visual pattern is smooth, textured, wood grain, marble, granite, colored appearance. The pattern can simulate the underlying hard surface or can change the appearance of the underlying surface for example changing the interior of an elevator from stainless steel to wood grain. It is further contemplated that the visual pattern can be light filtering to provide UV or other filtering that provides light protection to the interior of the building and or reduces cooling expenses.

This layer 21 provides a structural rigidity that maintains dimensional stability. It reacts like a sheet of material that is much thicker than the individual layer of material of stainless steel that is being used. The thickness of the graffiti covering skin 40 is sufficient to cover imperfections, scratches or gouges in the surface that is being covered.

The next layer 22 is a laminating adhesive. The laminating adhesive layer 22 provides bond between the visual pattern or filtering overlay 21 and the remainder of the backing. The laminating adhesive layer 22 bonds to a 4 Mil polyethylene terephthalate layer 23. While a 4 Mil layer of polyethylene terephthalate is identified, the layer 23 can be thinner or thicker. The 4 Mil thicknesses allows the skin to bridge most surface anomalies, scratches and gouges cause by use, abuse or vandalism to the surface that is to be covered. An removable adhesive (R.A.) layer 24 makes-up the majority of the graffiti covering skin. This removable adhesive (R.A.) layer 24 is a removable layer of adhesive that predominantly adheres to the 4 Mil polyethylene terephthalate layer 23 and provides a lower adhesive force to the layer the graffiti covering skin 10 is covering. The lower level of adhesion allows the graffiti covering skin to be removed from a host surface without leaving any adhesive or residue. The mounting adhesive is an acrylic based pressure sensitive adhesive which is initially a solvent based blend of self-cross linking acrylic polymers which include a blend of UV mitigating additives. The blend is specific to optimize tack, cohesive strength, release, and durability all designed to the specific nature of the application.

The release liner 29 is removable secured to the back of the removable adhesive (R.A.) layer 24. This release liner 29 is removed from the bonded layer prior to installation of the graffiti covering skin on the host surface.

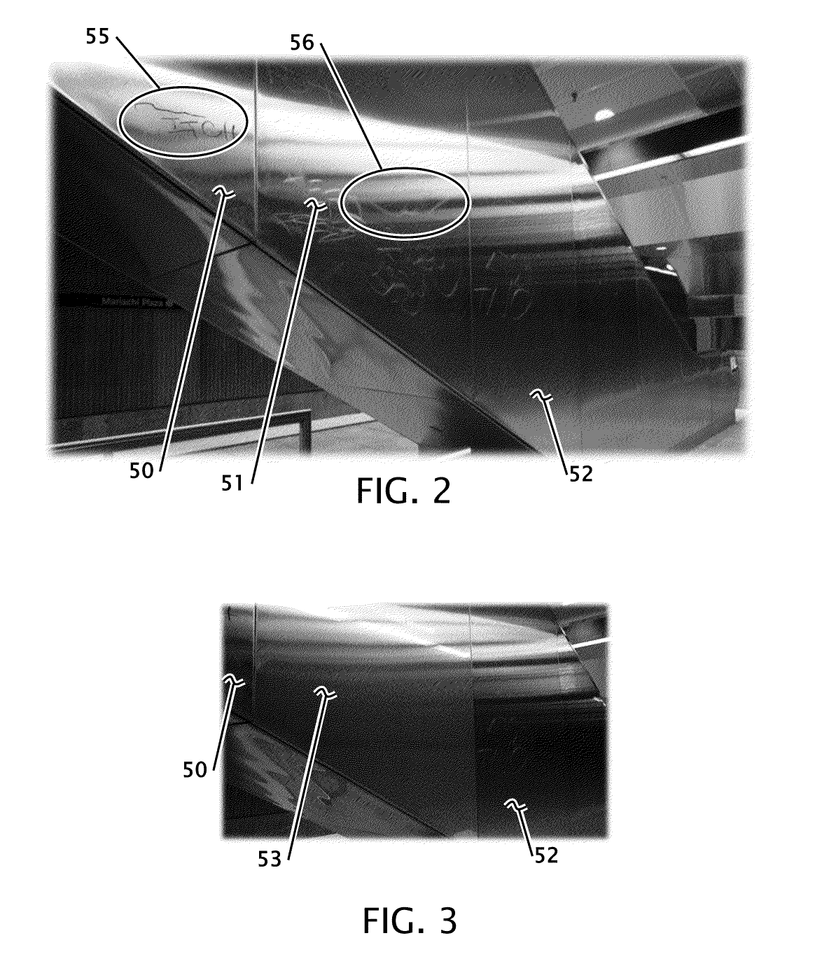

FIG. 2 shows a base surface that has been damaged by graffiti and FIG. 3 shows the base surface from FIG. 2 that has been partially covered with the graffiti skin. In FIG. 2 the host surface being covered is the side of an escalator. This figure shows the graffiti as permanent ink 55 written on the surface of the escalator side. This type of graffiti can be removed with strong chemicals or with abrasive cleaners that alter the cosmetic surface. Another typical form of graffiti is scratches or gouges in the surface 56. Because this type of vandalism alters the host surface, cleaning will not remove the damage. Again the use of abrasives will remove most of the damage, but the surface will be permanently altered. Installation of a thin surface protection allows the impression of the surface damage to be visible through the thin surface protection. The graffiti skin is a multilayer non-transparent film.

FIG. 2 shows three damaged panel sections 50, 51 and 52. FIG. 3 shows the middle panel has been covered with the disclosed graffiti covering skin 53. The surface of the underlying damaged panel 51 has not been altered, and the graffiti still remains, but is invisible due to the thick graffiti covering skin that rides over surface damage and scratches. The removable adhesive (R.A.) layer allows each individual skin 53 to be removed and replaced if future damage is cause by vandals or general wear and tear. Due to the fairly flat nature of the covering skin, application on cars or other automotive industry applications is limited.

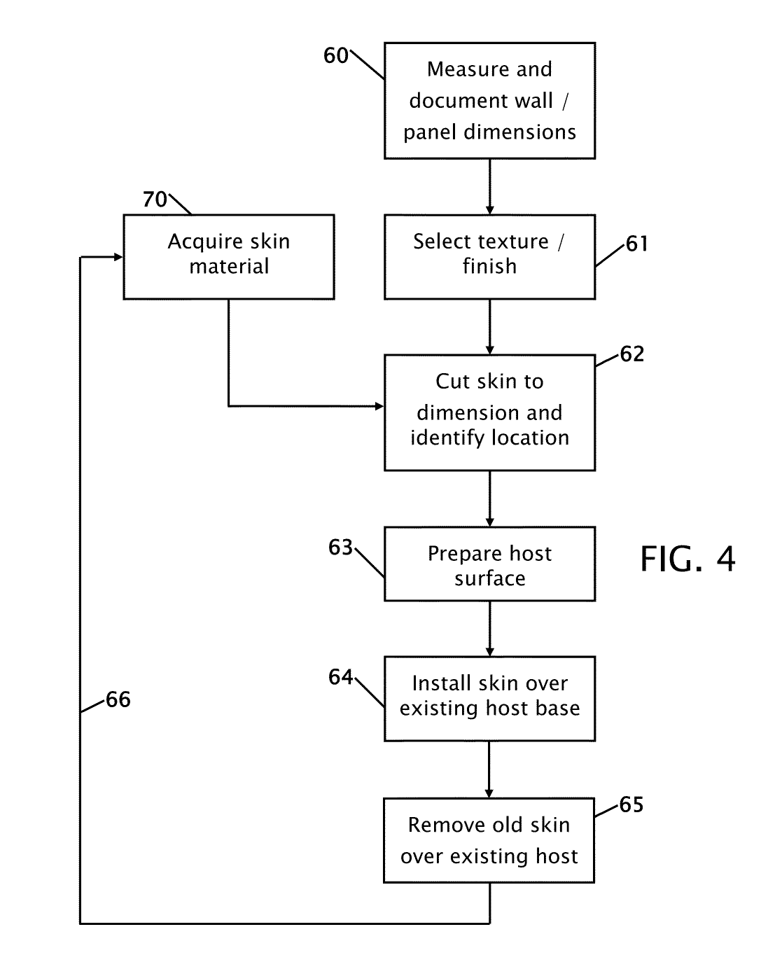

FIG. 4 shows the process that is used to prepare and cover a base surface with the graffiti covering skin. When the installation job is scheduled, one or more people will measure and document an entire job site. This could be a panel in an elevator, escalator, wall panel, counters, store front of windows, or transportation vehicle walls and or windows such as a train or bus. The process can further be applied to large areas such as an entire transit station or similar encompassing significant amounts of hard surfaces. The graffiti covering skin is applied in a wet process where the moisture is squeegeed out and air dried to create the removable bond.

Each panel is measured and documented 60 to ensure that cut pieces will be installed in the correct location with little or no trimming upon installation. This also ensure that if a panel needs to be replaced it can be cut and installed without requiring the panel to be re-measured.

The majority of the material used, predominantly, has a clear, mirror, filtering, brushed or grain surface appearance. The cosmetic appearance can be from printing, painting, screening, brushing, or other processes. Other finishes can be selected as well as brush/grain direction can be selected 61. Raw material is ordered 70 based upon the calculated area that is being covered and scrap that may exist from trimming and installation. A computer algorithm combines pieces and adjusts orientation to accommodate shapes, angles to optimize the graffiti covering skin material 62. Each piece is cut and identified for the job and location for placement.

At the job site the host surface is prepared by cleaning or removal of previous adhesives, oils, gum or other foreign material 63 that might cause problems with installation or adherence of the graffiti covering skin. The graffiti covering skin is then centered and installed onto the host wall or existing base 64. Over a period of time a surface can be damaged from vandals, age or a desire to update an appearance. Because the area has been documented in the past, the previous skin can be removed 65 and replacement will be the selected 66 cut and replaced on the host surface. This process can be repeated when desired or required without damage to the underlying host surface.

Heat is not required for application of the covering skin in the installation process. The covering skin is designed to be removable without leaving any adhesive or other material that must be separately removed.

Thus, specific embodiments of a graffiti covering skin have been disclosed. It should be apparent, however, to those skilled in the art that many more modifications besides those described are possible without departing from the inventive concepts herein. The inventive subject matter, therefore, is not to be restricted except in the spirit of the appended claims.

1. A host surface covering skin comprising:
at least an outer protective cosmetic layer;
a stainless steel visual pattern layer;
a laminating adhesive layer;
a polyethylene terephthalate layer;
a removable adhesive (R.A.) layer;
said removable adhesive layer being an acrylic based pressure sensitive adhesive blend of self-cross linking acrylic polymers, and
a release liner.

2. The host surface covering skin according to claim 1 wherein said at least an outer protective cosmetic layer is transparent or translucent.

3. The host surface covering skin according to claim 1 wherein said visual pattern layer is 0.0005″ to 0.0250″ thick.

4. The host surface covering skin according to claim 3 wherein said visual pattern layer has a printed or painted appearance of at least one of a group consisting of smooth, textured, wood grain, marble, granite, color, paint, wallpaper, filtering, brushed and stainless steel.

5. The host surface covering skin according to claim 1 wherein said host surface covering skin covers a host surface that has at least one of graffiti, vandalism, a surface anomalies, a scratch, a tear, general wear and a new or undamaged stainless steel host surface to offer protection from future damage.

6. The host surface covering skin according to claim 1 wherein said removable adhesive (R.A.) layer is removable with said at least an outer protective cosmetic layer, said visual pattern layer, said laminating adhesive layer and said polyethylene terephthalate layer on a host surface without leaving residue on said host surface.

7. The host surface covering skin according to claim 5 wherein said covering skin is cut to match dimensions of said host surface.

8. The host surface covering skin according to claim 5 wherein a plurality of host surfaces are measured and said plurality of host surfaces are nested on said host surface covering skin to optimize usage of said host surface covering skin.

9. The host surface covering skin according to claim 8 wherein said host surface covering skin is trimmed to match said plurality of host surfaces.

10. The host surface covering skin according to claim 9 further includes installing at host surfaces covering skin onto at least one of said plurality of host surfaces.

11. A host surface covering skin comprising:
at least an outer protective cosmetic layer;
a filtering layer;
a laminating adhesive layer;
a polyethylene terephthalate layer;
a removable adhesive (R.A.) layer;
said removable adhesive layer being an acrylic based pressure sensitive adhesive blend of self-cross linking acrylic polymers, and
a release liner.

12. The host surface covering skin according to claim 11 wherein said at least an outer protective cosmetic layer is transparent or translucent.

13. The host surface covering skin according to claim 11 wherein said metal or metalized layer is 0.0005″ to 0.0250 thick.

14. The host surface covering skin according to claim 13 wherein said filtering layer provides UV protection and reduces at least some light penetration through said filtering layer.

15. The host surface covering skin according to claim 11 wherein said host surface includes at least one of graffiti, vandalism, a surface anomalies, a scratch, a tear, general wear and a new or undamaged stainless steel host surface to offer protection from future damage.

16. The host surface covering skin according to claim 11 wherein said adhesive allows said skin to be removed from said host surface without leaving residue on said host surface.

17. The host surface covering skin according to claim 15 wherein said covering skin is cut to match dimensions of said host surface.

18. The host surface covering skin according to claim 15 wherein a plurality of host surfaces are measured and said plurality of host surfaces are nested on said host surface covering skin to optimize usage of said host surface covering skin.

19. The host surface covering skin according to claim 18 wherein said host surface covering skin is trimmed to match said plurality of host surfaces.

20. The host surface covering skin according to claim 19 further includes installing at host surfaces covering skin onto at least one of said plurality of host surfaces.
